(19) United States
(12) Patent Application Publication
(10) Pub. No.: US 2015/0182935 A1
(43) Pub. Date: Jul. 2, 2015

(54) MOISTURE GENERATING APPARATUS AND MOISTURE GENERATING METHOD

(71) Applicant: KABUSHIKI KAISHA TOSHIBA, Tokyo (JP)

(72) Inventor: Tatsunori ISOGAI, Yokkaichi (JP)

(21) Appl. No.: 14/481,087

(22) Filed: Sep. 9, 2014

(30) Foreign Application Priority Data
Dec. 27, 2013 (JP) 2013-272747

(51) Int. Cl. B01J 19/12; C01B 5/00

(52) U.S. Cl. CPC B01J 19/126; C01B 5/00; B01J 2219/0801; B01J 2219/0871; B01J 2219/1215; B01J 2219/1269; B01J 2219/1293

(57) ABSTRACT

In one embodiment, a moisture generating apparatus includes a power supply configured to generate a microwave. The apparatus further includes a container configured to contain a catalyst and to generate water molecules from hydrogen molecules and oxygen molecules using the catalyst. The apparatus further includes a waveguide configured to supply the microwave into the container to heat the catalyst.

### CROSS REFERENCE TO RELATED APPLICATION

This application is based upon and claims the benefit of priority from the prior Japanese Patent Application No. 2013-272747, filed on Dec. 27, 2013, the entire contents of which are incorporated herein by reference.

### FIELD

Embodiments described herein relate to a moisture generating apparatus and a moisture generating method.

### BACKGROUND

When a semiconductor device is manufactured, gaseous water (H₂O) is used as a process gas for heat treatment for reforming an insulator. For example, the gaseous water is generated by a method of dissociating a hydrogen molecule and an oxygen molecule into hydrogen atoms and oxygen atoms by using catalysis at a low temperature of about 350° C. and reacting the hydrogen atoms and the oxygen atoms. This method has an advantage that it is possible to suppress the clustering of water molecules and to form the water molecules at a monomolecular level. However, this method has a problem that when a catalyst is heated by an electric heater, the response speed of the electric heater is generally slow. For this reason, it is not realistic that the catalyst is heated only at the process time, and therefore the catalyst is always maintained at a temperature of about 350° C. Consequently, there is a problem that the power is wastefully consumed even at the standby time. Moreover, from the viewpoint of safety, it is necessary to pay attention such that the temperature of the catalyst does not exceed 571° C., which is the ignition temperature of hydrogen, by the heat from the electric heater and the reaction heat of hydrogen. Therefore, the upper limit of the flow rate of hydrogen roughly becomes 5 slm.

### BRIEF DESCRIPTION OF THE DRAWINGS

FIG. 1 is a cross-sectional view schematically illustrating a structure of a moisture generating apparatus of a first embodiment;

FIG. 2 is a schematic view illustrating a structure of a porous member of the first embodiment;

FIGS. 3A and 3B are perspective views schematically illustrating shapes of the porous member according to variations of the first embodiment; and

FIG. 4 is a flowchart illustrating a moisture generating method of the first embodiment.

### DETAILED DESCRIPTION

Embodiments will now be explained with reference to the accompanying drawings.

In one embodiment, a moisture generating apparatus includes a power supply configured to generate a microwave. The apparatus further includes a container configured to contain a catalyst and to generate water molecules from hydrogen molecules and oxygen molecules using the catalyst. The apparatus further includes a waveguide configured to supply the microwave into the container to heat the catalyst.

### First Embodiment

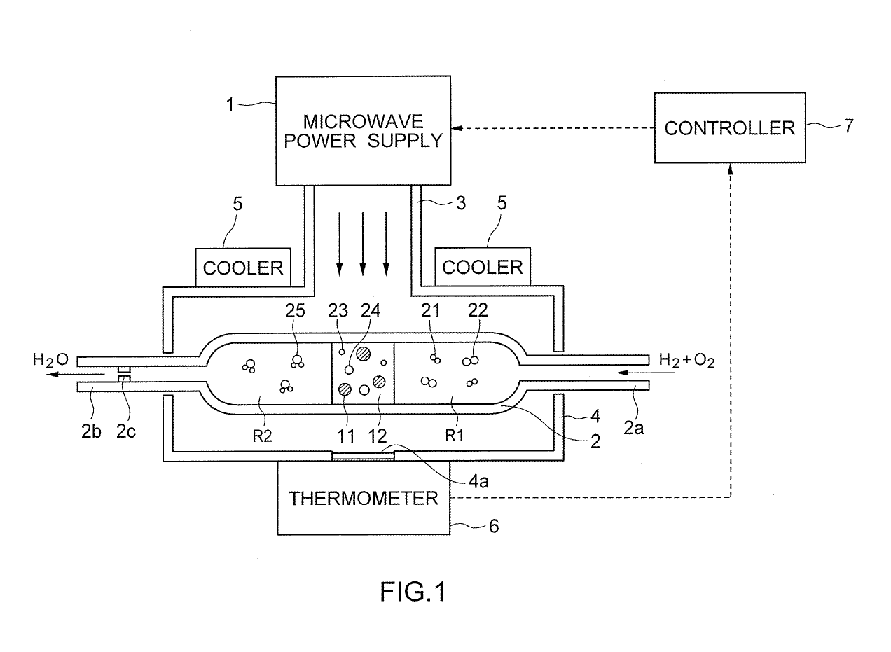

FIG. 1 is a cross-sectional view schematically illustrating a structure of a moisture generating apparatus of a first embodiment.

The moisture generating apparatus in FIG. 1 includes a microwave power supply 1 as an example of a power supply, a quartz tube 2 as an example of a container, a waveguide 3, a metallic housing 4 as an example of a housing, one or more coolers 5, a radiation thermometer 6 and a controller 7.

[Microwave Power Supply 1]

The microwave power supply 1 generates a microwave. A frequency of the microwave may be set to any value. For example, from the viewpoint of the manufacturing cost and reliability of the microwave power supply 1, the frequency of the microwave is desirable to be set to 2.45 GHz because the frequency of 2.45 GHz has been used in many commercial apparatuses such as a microwave oven.

[Quartz Tube 2]

The quartz tube 2 is a tube formed of quartz which is a transparent member. The quartz tube 2 includes a gas introduction portion 2a to introduce a hydrogen gas and an oxygen gas, and a gas emission portion 2b to emit gaseous water generated from the hydrogen gas and the oxygen gas. The quartz tube 2 further includes an orifice formation member 2c provided in the gas emission portion 2b so as to locally narrow a gas flow channel in the gas emission portion 2b.

Stoichiometrically, a ratio of flow rates of the hydrogen gas and the oxygen gas introduced from the gas introduction portion 2a is set to 2:1. However, to avoid that the hydrogen gas becomes excessive, the ratio of the flow rates of the hydrogen gas and the oxygen gas is set to K:1 (K<2) in the present embodiment. For example, the flow rate of the hydrogen gas is set to 5.0 slm, and the flow rate of the oxygen gas is set to 3.5 slm.

The orifice formation member 2c forms an orifice (small hole) in the gas emission portion 2b. The diameter of the gas flow channel in the gas emission portion 2b is set to a first diameter in portions other than the orifice formation member 2c, and set to a second diameter smaller than the first diameter in a portion where the orifice formation member 2c is provided. The second diameter of the present embodiment is set smaller than ⅕ times the first diameter, for example, is set to a value about 1/10 times the first diameter.

The reason for forming the orifice in the gas emission portion 2b of the present embodiment is to suppress the generation of plasma in the quartz tube 2. In a case where no orifice is provided in the gas emission portion 2b, when the pressure in the process apparatus in the downstream of the gas emission portion 2b becomes high pressure or low pressure, the pressure in the quartz tube 2 also becomes high pressure or low pressure. When the pressure in the quartz tube 2 is higher or lower than a normal pressure, the microwave is likely to excite plasma in the quartz tube 2. Therefore, the orifice is provided in the gas emission portion 2b of the present embodiment to maintain the pressure in the quartz tube 2 at around the atmospheric pressure. Accordingly, the present embodiment makes it possible to suppress the generation of plasma in the quartz tube 2.

The quartz tube 2 is configured to contain a catalyst 11. Specifically, the quartz tube 2 is configured to contain a porous member 12 to which the catalyst 11 having a form of grains is attached.

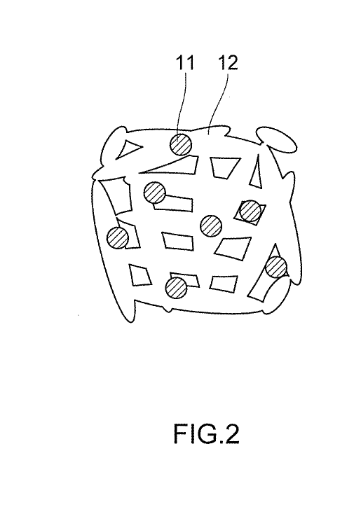

For example, the catalyst 11 is formed of metal such as platinum (Pt) and nickel (Ni). It is desirable that the form of the catalyst 11 is not a big mass but is a plurality of grains. The reason is that when the form of the catalyst 11 is a big mass, there is a possibility that the catalyst 11 discharges by the microwave. Moreover, it is desirable to set the diameter of the grains of the catalyst 11 smaller than 1 mm. The reason is that when the diameter of the grains of the catalyst 11 is larger than 1 mm, there is a possibility that the diameter of the grains of the catalyst 11 becomes larger than the wavelength of the microwave. In the present embodiment, the diameter of the grains of the catalyst 11 is set between 50 nm and 500 For example, the porous member 12 to which the catalyst 11 is attached is made by soaking the porous member 12 in a liquid including the catalyst 11. In this case, the catalyst 11 is attached to the inner surface of pores of the porous member 12 and the outer surface of the porous member 12 (see FIG. 2). FIG. 2 is a schematic view illustrating a structure of the porous member 12 of the first embodiment. Such a structure has an advantage that it is easy to uniformly heat the catalyst 11 by the microwave. It is desirable that the porous member 12 is formed of a material that easily absorbs the microwave. For example, the porous member 12 is formed of a dielectric such as aluminum oxide.

The space in the quartz tube 2 is separated into a first region R1 on the side of the gas introduction portion 2a and a second region R2 on the side of the gas emission portion 2b by the porous member 12. Therefore, the hydrogen gas and the oxygen gas introduced from the gas introduction portion 2a into the quartz tube 2 surely enter the porous member 12.

[Waveguide 3]

The microwave generated from the microwave power supply 1 is supplied into the quartz tube 2 through the waveguide 3 to heat the catalyst 11. Specifically, when the catalyst 11 is irradiated by the microwave, the microwave is absorbed to the catalyst 11 and therefore the catalyst 11 is heated. Furthermore, when the porous member 12 is irradiated with the microwave, the microwave is absorbed to the porous member 12 and therefore the porous member 12 is heated, so that the catalyst 11 is heated by the heat of the porous member 12.

The porous member 12 is provided at the central portion of the quartz tube 2. Meanwhile, the waveguide 3 is disposed immediately above the central portion of the quartz tube 2. Therefore, the porous member 12 is provided at a place where the porous member 12 is likely to be irradiated by the microwave.

The quartz tube 2 is used to generate water molecules from hydrogen molecules and oxygen molecules using the catalyst 11. Reference numerals 21 and 22 indicate the hydrogen molecules included in the hydrogen from the gas introduction portion 2a and the oxygen molecules included in the oxygen from the gas introduction portion 2a, respectively.

When the hydrogen molecules 21 pass the porous member 12, the hydrogen molecules 21 are dissociated into hydrogen atoms 23 by an effect of the catalyst 11. Similarly, when the oxygen molecules 22 pass the porous member 12, the oxygen molecules 22 are dissociated into oxygen atoms 24 by an effect of the catalyst 11. The hydrogen atoms 23 then react with the oxygen atoms 24 to generate water molecules 25. The water molecules 25 are emitted from the gas emission portion 2b as the gaseous water. It is desirable that the quartz tube 2 contains a sufficient amount of the catalyst 11 such that all of the hydrogen molecules 21 passing the porous member 12 become the water molecules 25.

While the hydrogen molecules 21 and the oxygen molecules 22 are introduced from the gas introduction portion 2a, the microwave power supply 1 generates the microwave. Therefore, when the hydrogen molecules 21 and the oxygen molecules 22 pass the porous member 12, the catalyst 11 is heated by the microwave. In the present embodiment, while the water molecules 25 are generated from the hydrogen molecules 21 and the oxygen molecules 22, the temperature of the catalyst 11 is set at 300° C. to 450° C. (for example, 350° C.). Therefore, the present embodiment makes it possible to perform a moisture generation process while securing a sufficient margin of 100° C. or more between the temperature of the catalyst 11 and the ignition temperature of hydrogen (571° C.).

It is desirable that the moisture generating apparatus of the present embodiment includes a structure for maintaining a temperature of a pipe of the gas emission portion 2b after the orifice formation member 2c at 100° C. or more. The reason is to prevent the gaseous water from returning to liquid water in the gas emission portion 2b and prevent the liquid water from remaining in the pipe of the gas emission portion 2b. For example, such a structure can be realized by wrapping a heater around the pipe of the gas emission portion 2b.

Meanwhile, the moisture generating apparatus of the present embodiment does not have to maintain the temperature of the pipe of the gas emission portion 2b before the orifice formation member 2c and the temperature of the quartz tube 2 at 100° C. or more. The reason is that even if the gaseous water in these regions returns to the liquid water, the liquid water returns to the gaseous water again when the liquid water is heated by the microwave. Therefore, the temperature of the pipe of the gas emission portion 2b before the orifice formation member 2c and the temperature of the quartz tube 2 may be maintained at, for example, around the ambient temperature by the coolers 5 described later. To maintain these temperatures at around the ambient temperature provides an advantage that it is possible to promptly cool the catalyst 11 and the porous member 12, for example.

[Metallic Housing 4]

The metallic housing 4 contains the quartz tube 2. The metallic housing 4 has a window 4a to measure the temperature of the catalyst 11 in the quartz tube 2. The window 4a is formed of a transparent material such as glass.

[Coolers 5]

The coolers 5 are used to cool the catalyst 11 and the porous member 12. For example, the coolers 5 adopt a water-cooling scheme. The water-cooling scheme provides an advantage that it is possible to promptly cool the catalyst 11 and the porous member 12.

[Radiation Thermometer 6]

The radiation thermometer 6 measures the temperature of the catalyst 11 by measuring an electromagnetic wave emitted from the catalyst 11 via the window 4a. The radiation thermometer 6 outputs the measurement result of the temperature of the catalyst 11 to the controller 7.

[Controller 7]

The controller 7 controls the operation of the moisture generating apparatus. For example, in a case where the temperature of the catalyst 11 measured by the radiation thermometer 6 is too high, the controller 7 decreases the input power to the microwave power supply 1 to decrease the temperature of the catalyst 11. Moreover, in a case where the temperature of the catalyst 11 measured by the radiation thermometer 6 is too low, the controller 7 increases the input power to the microwave power supply 1 to raise the temperature of the catalyst 11. In this way, the controller 7 can monitor the temperature of the catalyst 11 by the radiation thermometer 6 and can maintain the temperature of the catalyst 11 by feedback control.

While the water molecules 25 are generated, the controller 7 of the present embodiment controls the input power to the microwave power supply 1 within a range of 0 to 1.5 kW. Moreover, while the water molecules 25 are generated, the controller 7 of the present embodiment maintains the temperature of the catalyst 11 within a range of 300 to 450° C.

(1) Details of Moisture Generating Apparatus of First Embodiment

With reference to FIG. 1, details of the moisture generating apparatus of the first embodiment are described.

When an object is irradiated with a microwave of a GHz band, the temperature of the object rises by dielectric heating or induction heating. In a case where this object is a dielectric, the microwave deeply enters the dielectric and causes the dielectric to generate heat from its inside. This phenomenon is called microwave internal heating. The time response of this internal heating is fast and can bring the object to a target temperature in less than one minute.

Therefore, the present embodiment makes it possible to heat the catalyst 11 at high speed by using the microwave to heat the catalyst 11 and the porous member 12. Therefore, the present embodiment makes it possible to perform a control to power on the microwave power supply 1 only while the water molecules 25 are generated and to power off the microwave power supply 1 while the generation of the water molecules 25 stands by. The reason is that even if the temperature of the catalyst 11 decreases at the time of the standby, it is possible to raise the temperature of the catalyst 11 at high speed at the time of the generation of the water molecules 25.

Therefore, in the present embodiment, the microwave is generated to heat the catalyst 11 only while the water molecules 25 are generated, and the generation of the microwave is stopped to stop the heating of the catalyst 11 while the generation of the water molecules 25 stands by.

Therefore, the present embodiment makes it possible to reduce the power consumption of the moisture generating apparatus.

Moreover, in a case where the catalyst 11 is heated by an electric heater like a conventional method, even if the power input to the heater is stopped, the catalyst 11 is not rapidly cooled due to the residual heat of the heater. Therefore, from the viewpoint of safety, it is necessary to pay attention such that the temperature of the catalyst 11 does not exceed 571° C., which is the ignition temperature of hydrogen, by the heat of the heater and the reaction heat of hydrogen.

Meanwhile, when the microwave power supply 1 is powered off in the present embodiment, the catalyst 11 loses a heat source and is rapidly cooled. Therefore, in a case where the temperature of the catalyst 11 is too high, it is possible to control the temperature of the catalyst 11 precisely and promptly by the control of powering on and off the microwave power supply 1 while monitoring the temperature of the radiation thermometer 6. Therefore, the present embodiment makes it possible to sufficiently secure the safety even in a case where hydrogen and oxygen having large flow rates are reacted.

Moreover, in the case where the catalyst 11 is heated by the electric heater like the conventional method, a cooling fin is generally used to cool the metallic housing 4 heated by the heater. Meanwhile, a microwave in the present embodiment mainly heats the catalyst 11 and the porous member 12 and hardly heats the metallic housing 4. Therefore, the present embodiment makes it possible to form the moisture generating apparatus without using the cooling fin and realize the moisture generating apparatus of a simple structure.

(2) Variations of First Embodiment

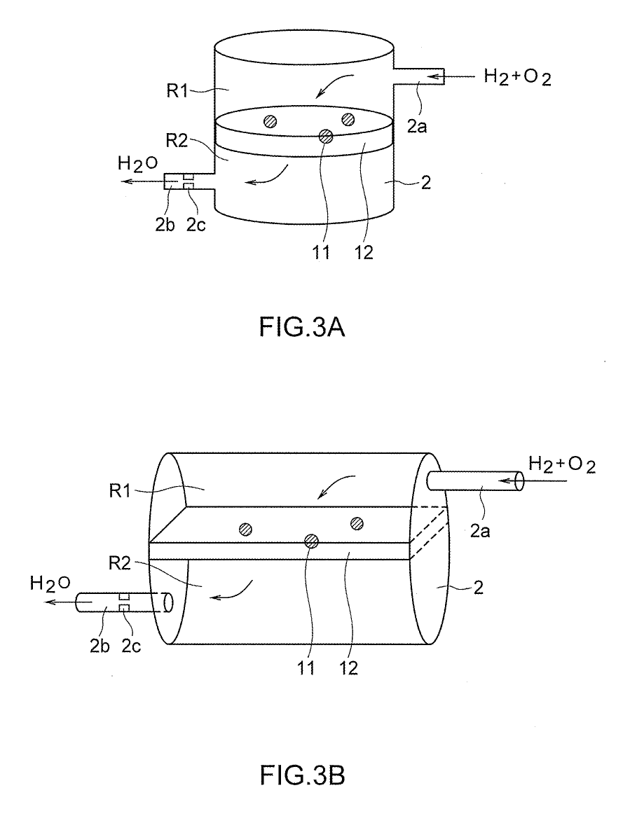

FIGS. 3A and 3B are perspective views schematically illustrating shapes of the porous member 12 according to variations of the first embodiment.

In the present embodiment, it is desirable that the porous member 12 can be cooled promptly. Therefore, the porous member 12 in FIG. 3A and the porous member 12 in FIG. 3B have the shapes which are easy to be cooled promptly. Specifically, the porous member 12 in FIG. 3A and the porous member 12 in FIG. 3B have the shapes whose areas of the upper surfaces are wide. As illustrated in FIG. 1, the moisture generating apparatus of the present embodiment includes the coolers 5 and the waveguide 3 on the side of the upper surface of the porous member 12. Therefore, the porous member 12 whose area of the upper surface is wide as illustrated in FIGS. 3A and 3B can be cooled promptly.

The shape of the quartz tube 2 in FIG. 3A is a cylinder shape with an axis that vertically extends. Therefore, the porous member 12 in FIG. 3A has a disc shape. On the other hand, the shape of the quartz tube 2 in FIG. 3B is a cylinder shape with an axis that horizontally extends. Therefore, the porous member 12 in FIG. 3B has a substantially rectangular plate shape.

The porous member 12 of the present embodiment may have the shape illustrated in FIG. 3A or may have the shape illustrated in FIG. 3B. Moreover, the porous member 12 of the present embodiment may have another shape whose area of the upper surface is wide. In a case where the coolers 5 are disposed on a first-direction side of the porous member 12 (for example, on the side of the gas introduction portion 2a or the side of the gas emission portion 2b), the area on the first-direction side of the porous member 12 may be widely set.

(3) Moisture Generating Method of First Embodiment

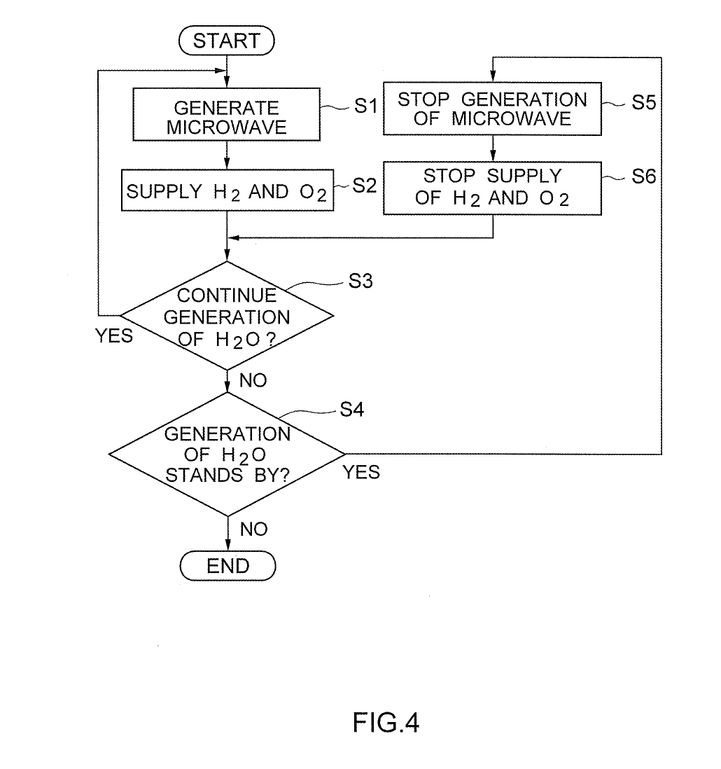

FIG. 4 is a flowchart illustrating a moisture generating method of the first embodiment.

When the water is generated, the microwave power supply 1 is powered on to generate the microwave (step S1). As a result, the catalyst 11 in the quartz tube 2 is heated by the microwave directly or indirectly.

The hydrogen (hydrogen molecules 21) and the oxygen (oxygen molecules 22) are then introduced from the gas introduction portion 2a into the quartz tube 2 (step S2). As a result, the hydrogen molecules 21 and the oxygen molecules 22 are respectively dissociated into the hydrogen atoms 23 and the oxygen atoms 24 by the effects of the catalyst 11, and the water molecules 25 are generated from the hydrogen atoms 23 and the oxygen atoms 24. The gaseous water (water molecules 25) is then emitted from the gas emission portion 2b.

The order of starting steps S1 and S2 can be arbitrarily set. For example, steps S1 and S2 may be started at the same time. Moreover, step S2 may be started after starting step S1. Also, step S1 may be started after starting step S2.

Next, in the case of continuing the generation of the water (step S3), the processing in steps S1 and S2 is continued. In this way, while the water is generated in the present embodiment, the microwave is generated from the microwave power supply 1, and the hydrogen and the oxygen are introduced into the quartz tube 2.

On the other hand, in the case of the standing-by without finishing the generation of the water (step S4), the processing in steps S5 and S6 is performed. Therefore, while the generation of the water stands by in the present embodiment, the generation of the microwave from the microwave power supply 1 is stopped, and the introduction of the hydrogen and the oxygen into the quartz tube 2 is stopped.

The processing in steps S1 to S6 may be automatically performed by the controller 7 or may be manually performed by a user.

As described above, in the present embodiment, the catalyst 11 for generating the water molecules 25 from the hydrogen molecules 21 and the oxygen molecules 22 is heated by the microwave directly or indirectly. Therefore, the present embodiment makes it possible to reduce the power consumption and to improve the safety when the gaseous water is generated using the catalyst 11.

While certain embodiments have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from the spirit of the inventions. The accompanying claims and their equivalents are intended to cover such forms or modifications as would fall within the scope and spirit of the inventions.

1. A moisture generating apparatus comprising:
a power supply configured to generate a microwave;
a container configured to contain a catalyst and to generate water molecules from hydrogen molecules and oxygen molecules using the catalyst; and
a waveguide configured to supply the microwave into the container to heat the catalyst.

2. The apparatus of claim 1, wherein the container is configured to contain a porous member to which the catalyst is attached.

3. The apparatus of claim 2, wherein the porous member is formed of a dielectric.

4. The apparatus of claim 1, wherein the catalyst has a form of a grain.

5. The apparatus of claim 4, wherein a diameter of the catalyst is smaller than 1 mm.

6. The apparatus of claim 1, wherein the catalyst is formed of platinum or nickel.

7. The apparatus of claim 1, wherein the waveguide irradiates the catalyst with the microwave.

8. The apparatus of claim 1, wherein the container comprises:
a gas introduction portion to introduce hydrogen including the hydrogen molecules and oxygen including the oxygen molecules;
a gas emission portion to emit water including the water molecules; and
a member provided in the gas emission portion so as to locally narrow a gas flow channel in the gas emission portion.

9. The apparatus of claim 1, further comprising a housing which contains the container and includes a window to measure a temperature of the catalyst in the container.

10. The apparatus of claim 1, further comprising:
a thermometer configured to measure a temperature of the catalyst; and
a controller configured to control the temperature of the catalyst based on the temperature measured by the thermometer.

11. The apparatus of claim 10, wherein
the controller causes the power supply to generate the microwave while the water molecules are generated; and
the controller causes the power supply to stop the generation of the microwave while the generation of the water molecules stands by.

12. The apparatus of claim 10, wherein the controller maintains the temperature of the catalyst at 300° C. to 450° C. while the water molecules are generated.

13. A moisture generating method comprising:
generating a microwave;
supplying the microwave into a container containing a catalyst to heat the catalyst;
introducing hydrogen molecules and oxygen molecules into the container;
generating water molecules from the hydrogen molecules and the oxygen molecules using the catalyst; and
emitting the water molecules from the container.

14. The method of claim 13, wherein
the microwave is generated while the water molecules are generated; and
the generation of the microwave is stopped while the generation of the water molecules stands by.

15. The method of claim 13, wherein the temperature of the catalyst is maintained at 300° C. to 450° C. while the water molecules are generated.

16. The method of claim 13, wherein the microwave is supplied into the container containing a porous member to which the catalyst is attached.

17. The method of claim 16, wherein the porous member is formed of a dielectric.

18. The method of claim 13, wherein the catalyst has a form of a grain.

19. The method of claim 18, wherein a diameter of the catalyst is smaller than 1 mm.

20. The method of claim 13, wherein the microwave is supplied into the container to irradiate the catalyst with the microwave.
